(19) United States
(12) Patent Application Publication
(10) Pub. No.: US 2021/0083316 A1
(43) Pub. Date: Mar. 18, 2021

(54) SECONDARY CELL WITH NONAQUEOUS ELECTROLYTE

(71) Applicant: TDK CORPORATION, Tokyo (JP)

(72) Inventors: Hiroshi SASAGAWA, Tokyo (JP); Yasuyuki KAWANAKA, Tokyo (JP)

(73) Assignee: TDK CORPORATION, Tokyo (JP)

(21) Appl. No.: 16/633,558

(22) PCT Filed: Dec. 25, 2018
(86) PCT No.: PCT/JP2018/047556

§ 371 Date: Jan. 23, 2020

(30) Foreign Application Priority Data
Dec. 26, 2017 (JP) 2017-248931

(51) Int. Cl. H01M 10/056; H01M 10/0587

(52) U.S. Cl. CPC H01M 10/056; H01M 2300/0025; H01M 2300/002; H01M 10/0587

(57) ABSTRACT

The secondary cell with the nonaqueous electrolyte includes: the wound body in which an electrode group including the positive electrode, the negative electrode, and a separator sandwiched therebetween is wound in a flat shape; and the nonaqueous electrolyte having the wound body immersed therein. The wound body, in the central section within at least five layers from the inside of the wound body, includes a gap between adjacent layers of the electrode group and a length Gn of the gap in a major axis direction of the wound body when viewed from the axial direction of the wound body fulfills a relationship of 0.09/n−0.003≤Gn≤0.98/n−0.093 (1≤n≤4).

### TECHNICAL FIELD

The present invention relates to a secondary cell with a nonaqueous electrolyte.

Priority is claimed on Japanese Patent Application No. 2017-248931, filed Dec. 26, 2017, the content of which is incorporated herein by reference.

### BACKGROUND ART

As secondary cells with a nonaqueous electrolyte, batteries having a wound body obtained by winding a positive electrode and a negative electrode with a separator therebetween enclosed in an exterior body are known.

Patent Literature 1 describes a flat type wound body in which a density of the negative electrode active material layer in a curved section is higher than that of the negative electrode active material layer in a flat section. It is described that, by accomplishing this constitution, it is possible to minimize lithium deposition in the curved section during a charge/discharge cycle.

Also, Patent Literature 2 describes that variation in battery capacity of a secondary cell with a nonaqueous electrolyte is reduced by decreasing a density of an active material in a portion in which a curvature of a wound body is the smallest to be lower than that of other regions.

Furthermore, Patent Literature 3 describes that a current collector can be prevented from being broken by increasing a density of a binder in a positive electrode-containing layer on a surface side thereof.

### CITATION LIST

### Patent Literature

### Patent Literature 1

Japanese Unexamined Patent Application, First Publication No. 2016-81605

### Patent Literature 2

Japanese Unexamined Patent Application, First Publication No. 2007-324074

### Patent Literature 3

Japanese Unexamined Patent Application, First Publication No. 2017-84769

### SUMMARY OF INVENTION

### Technical Problem

However, even when the secondary cells with a nonaqueous electrolyte described in Patent Literature 1 to 3 are used, the secondary cells with a nonaqueous electrolyte do not exhibit adequate input characteristics in some cases.

The present invention was made in view of the above-described problems and an object of the present invention is to provide a secondary cell with a nonaqueous electrolyte capable of improving input characteristics.

The inventors of the present invention have found that it is difficult for an inner central section of a wound body to become impregnated with an electrolyte, and particularly, if a density of an active material layer is high, the influence thereof is significant. In the case of a flat wound body, a density of an active material layer of a curved section is higher than a density of an active material layer of a flat section. If it is not possible to supply a sufficient electrolyte to an active material layer of a curved section, input characteristics of a secondary cell with a nonaqueous electrolyte deteriorate.

Thus, it has been found that it is possible to supply sufficient electrolyte to a curved section as well by intentionally providing a gap in a central section of a wound body. Furthermore, it has been found that it is possible to improve input characteristics of a secondary cell with a nonaqueous electrolyte by setting a size of this gap within a predetermined range.

That is to say, in order to solve the above-mentioned problems, the following means are provided.

(1) A secondary cell with a nonaqueous electrolyte according to a first aspect includes: a wound body in which an electrode group including a positive electrode, a negative electrode, and a separator sandwiched therebetween is wound in a flat shape; and a nonaqueous electrolyte with which the wound body is impregnated, wherein the wound body, in a central section within at least five layers from the inside of the wound body, includes a gap between adjacent layers of the electrode group and a length Gn of the gap in a major axis direction of the wound body when viewed from an axial direction of the wound body fulfills a relationship of 0.09/n−0.003≤Gn≤0.98/n−0.093 (1≤n≤4).

(2) In the secondary cell with a nonaqueous electrolyte according to the above aspect, at any end surface of the wound body in the axial direction, the negative electrode may protrude outward in the axial direction from the adjacent positive electrode, and an amount of protrusion may be 0.5 mm or more and 2.5 mm or less.

(3) In the secondary cell with a nonaqueous electrolyte according to the above aspect, the nonaqueous electrolyte may include cyclic carbonates and chain carbonates, and the cyclic carbonates may include at least propylene carbonate.

(4) In the secondary cell with a nonaqueous electrolyte according to the above aspect, an electrode density of the positive electrode may be 3.0 g/cm³ or more and 3.9 g/cm³ or less.

### Advantageous Effects of Invention

According to the secondary cell with a nonaqueous electrolyte associated with the above aspects, it is possible to improve input characteristics.

### BRIEF DESCRIPTION OF DRAWINGS

FIG. 1 is a schematic diagram of a secondary cell with a nonaqueous electrolyte according to an embodiment.

FIG. 2 is an expanded view of a wound body in the secondary cell with a nonaqueous electrolyte according to the embodiment.

FIG. 3 is an enlarged cross-sectional schematic diagram of a characteristic part of the wound body in the secondary cell with a nonaqueous electrolyte according to the embodiment.

FIG. 4 illustrates results associated with measurement with respect to a cross-sectional photograph of the characteristic part of the wound body using X-ray CT.

FIG. 5 is a transmission X-ray photograph captured using an X-ray imaging device (manufactured by GUANGDONG ZHENGYE TECHNOLOGY Co., Ltd.; output 55 kW-45 μA).

FIG. 6 is an enlarged schematic plan view of an end surface of the wound body in a winding axis direction thereof.

### DESCRIPTION OF EMBODIMENTS

An embodiment will be described in detail below with reference to the drawings as appropriate. In the drawings used in the following description, in order to facilitate understanding of the characteristics of the present invention, for the sake of convenience, characteristic parts may be illustrated in an enlarged manner in some cases and a dimensional ratios or the like in each constituent element may be different from that of each of actual elements in some cases. The materials, dimensions, and the like exemplified in the following description are examples and the present invention is not limited thereto and can be appropriately modified and realized without departing from the gist of the present invention.

[Secondary Cell with Nonaqueous Electrolyte]

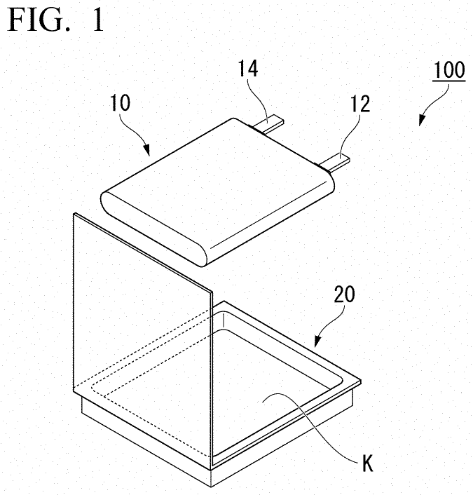

FIG. 1 is a schematic diagram of a secondary cell with a nonaqueous electrolyte according to an embodiment. A secondary cell 100 with a nonaqueous electrolyte illustrated in FIG. 1 includes a wound body 10 and an exterior body 20. The wound body 10 is accommodated in an accommodation space K disposed in the exterior body 20. For the sake of easy understanding, FIG. 1 illustrates a state immediately before the wound body 10 is accommodated in the exterior body 20.

(Wound Body)

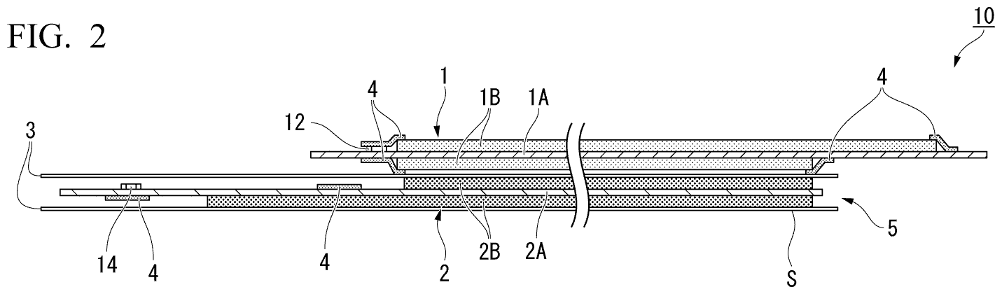

FIG. 2 is an expanded view of the wound body 10 in the secondary cell with a nonaqueous electrolyte according to the embodiment. As illustrated in FIG. 2, the wound body 10 is prepared by winding an electrode group 5. When the wound body 10 is unfolded, as illustrated in FIG. 2, an outermost circumferential surface S of the wound body 10 is a lower surface of the electrode group 5 on a right side thereof.

The electrode group 5 includes a positive electrode 1, a negative electrode 2, and a separator 3 sandwiched therebetween. A positive electrode terminal 12 and a negative electrode terminal 14 for electrical connection with the outside are connected to the positive electrode 1 and the negative electrode 2 respectively (refer to FIG. 1). The positive electrode terminal 12 and the negative electrode terminal 14 are made of a conductive material such as aluminum, nickel, and copper. The positive electrode terminal 12 is connected to the positive electrode 1 and the negative electrode terminal 14 is connected to the negative electrode 2. A connection method may be welding or screwing. It is desirable that the positive electrode terminal 12 and the negative electrode terminal 14 be protected using an insulating tape 4 to prevent a short circuit thereof.

The positive electrode 1 includes a plate-like (film-like) positive electrode current collector 1A and a positive electrode active material layer 1B. The positive electrode active material layer 1B is disposed on at least one surface of the positive electrode current collector 1A. The negative electrode 2 includes a plate-like (film-like) negative electrode current collector 2A and the negative electrode active material layer 2B. The negative electrode active material layer 2B is disposed on at least one surface of the negative electrode current collector 2A.

The positive electrode current collector 1A may be a conductive plate member, and for example, a thin metal plate formed of aluminum, copper, or nickel foil can be used for the positive electrode current collector 1A.

A thickness of the positive electrode current collector 1A is preferably 10 μm or more and 20 μm or less, more preferably 12 μm or more and 15 μm or less, and even more preferably 15 μm.

Electrode active materials in which occlusion and release of ions, desorption and insertion (intercalation) of ions, or doping and dedoping of ions and counter anions can reversibly advance are used as a positive electrode active material used for the positive electrode active material layer 1B. As the ions, for example, lithium ions, sodium ions, magnesium ions, and the like can be used and it is particularly desirable to use lithium ions.

For example, in the case of a lithium ion secondary cell, lithium cobalt oxide (LiCoO₂), lithium nickel oxide (LiNiO₂), lithium manganese oxide (LiMnO₂), lithium manganese spinel (LiMn₂O₄), and a composite metal oxide represented by the general expression: LiNiₓCo_{y}Mn_{z}MₐO₂ (x+y+z+a=1, 0≤x<1, 0≤y<1, 0≤z<1, 0≤a<1, and M indicates one or more elements selected from Al, Mg, Nb, Ti, Cu, Zn, and Cr), a lithium vanadium compound (LiV₂O₅), an olivine type LiMPO₄ (here, M indicates one or more elements selected from Co, Ni, Mn, Fe, Mg, Nb, Ti, Al, and Zr or VO), a composite metal oxide such as lithium titanium oxide (Li₄Ti₅O₁₂) and LiNiₓCo_{y}Al_{z}O₂ (0.9<x+y+z<1.1), a polyacetylene, a polyaniline, a polypyrrole, a polythiophene, a polyacene, and the like can be used as a positive electrode active material.

Among the above, it is desirable that any of LiCoO₂ and a composite metal oxide represented by the general expression: LiNiₓCo_{y}M_{z}O₂ (0.9<x+y+z<1.1, 0.6≤x<1, 0.2≤y≤0.4, 0.03≤z<0.2, and M indicates one or more elements selected from Al or Mn) be used as a positive electrode active material. Secondary cells with a nonaqueous electrolyte containing these positive electrode active materials have a large charge/discharge capacity and excellent cycle characteristics. Furthermore, these positive electrode active materials have a high capacity and an energy density of the entire secondary cell with a nonaqueous electrolyte is increased if the density of the positive electrode active material layer is increased. In addition, even when the density of the positive electrode active material layer has been increased, it is possible to supply a sufficient amount of a nonaqueous electrolyte through a gap between adjacent electrode groups 5 in a curved section. Therefore, it is possible to minimize deterioration in input characteristics of a curved section with respect to a flat section.

Also, the positive electrode active material layer 1B may have a conductive material. Examples of the conductive material include a carbon powder such as carbon blacks, a carbon nanotube, a carbon material, a fine metal powder such as copper, nickel, stainless steel, and iron, a mixture of a carbon material and a fine metal powder, and a conductive oxide such as an ITO. In the case in which sufficient conductivity can be ensured with only the positive electrode active material, the positive electrode active material layer 1B may not include a conductive material.

Furthermore, the positive electrode active material layer 1B includes a binder. A well-known binder can be used for the binder. Examples of the binder include fluororesins such as polyvinylidene fluoride (PVDF), polytetrafluoroethylene (PTFE), a tetrafluoroethylene-hexafluoropropylene copolymer (FEP), a tetrafluoroethylene-perfluoroalkyl vinyl ether copolymer (PFA), an ethylene-tetrafluoroethylene copolymer (ETFE), polychlorotrifluoroethylene (PCTFE), an ethylene-chlorotrifluoroethylene copolymer (ECTFE), and polyvinyl fluoride (PVF).

In addition to the above, as the binder, for example, vinylidene fluoride-based fluororubbers such as vinylidene fluoride-hexafluoropropylene-based fluororubbers (VDF-HFP-based fluororubbers), vinylidene fluoride-hexafluoropropylene-tetrafluoroethylene-based fluororubbers (VDF-HFP-TFE-based fluororubbers), vinylidene fluoride-pentafluoropropylene-based fluororubbers (VDF-PFP-based fluororubbers), vinylidene fluoride-pentafluoropropylene-tetrafluoroethylene-based fluororubbers (VDF-PFP-TFE-based fluororubbers), vinylidene fluoride-perfluoromethyl vinyl ether-tetrafluoroethylene-based fluororubbers (VDF-PFMVE-TFE-based fluororubbers), and vinylidene fluoride-chlorotrifluoroethylene-based fluororubbers (VDF-CTFE-based fluororubbers) may be used.

A thickness of the positive electrode active material layer 1B is preferably 20 μm or more and 60 μm or less and more preferably 30 μm or more and 50 μm or less. Here, a thickness of the positive electrode active material layer 1B refers to a thickness of the positive electrode active material layer 1B formed on one surface of the positive electrode current collector 1A.

An electrode density of the positive electrode active material layer 1B is preferably 3.0 g/cm³ or more and 3.9 g/cm³ or less and more preferably 3.3 g/cm³ or more and 3.8 g/cm³ or less. Here, the electrode density of the positive electrode active material layer 1B refers to an average density of the positive electrode active material layer 1B located on one surface of the positive electrode current collector 1A and including a positive electrode active material, a conductive material, and a binder.

The electrode density of the positive electrode active material layer 1B is calculated by dividing the weight per unit area of the positive electrode active material layer 1B by a thickness. The weight per unit area of the positive electrode active material layer 1B is calculated by calculating the weight per unit area of the positive electrode 1 and then subtracting the weight per unit area of the positive electrode current collector 1A from the calculated weight per unit area of the positive electrode 1.

The average density of the positive electrode active material layer 1B is calculated as an average value of electrode densities of the positive electrode active material layer 1B at a plurality of locations. The electrode density of the positive electrode active material layer 1B at each location is obtained through the above-described procedure. A plurality of locations are an arbitrary five or more locations on the positive electrode active material layer 1B.

A negative electrode active material used for the negative electrode active material layer 2B may be a compound from which ions can be occluded/released and the negative electrode active material used for a well-known secondary cell with a nonaqueous electrolyte can be used. Examples of the negative electrode active material include particles which contain alkali or alkaline earth metals such as metallic lithium, graphite (natural graphite and artificial graphite) from which ions can be occluded/released, carbon nanotubes, carbon materials such as non-graphitizable carbon, graphitizable carbon, and low-temperature calcined carbon, metals including aluminum, silicon, tin, germanium, and the like which can combine with metals such as lithium, amorphous compounds mainly composed of oxides such as SiOₓ (0<x<2) and tin dioxide, lithium titanium oxide (Li₄Ti₅O₁₂), and the like.

Although these negative electrode active materials exhibit a large charge/discharge capacity, a volume expansion associated with a charge/discharge reaction is large. If the negative electrode 2 using these as a negative electrode active material is used for the wound body 10, even when volume expansion occurs, a gap G in a curved section minimizes deformation of the wound body 10. For this reason, the secondary cell with a nonaqueous electrolyte can increase the charge/discharge capacity without impairing the input characteristics.

Also, among the above, it is desirable to use any of graphite (natural graphite and artificial graphite), silicon, germanium, and SiOₓ (0<x<2) as a negative electrode active material. In addition, it is more desirable to use a mixture (hereinafter referred to as a “mixed based”) of graphite (natural graphite and artificial graphite) and any selected from the group consisting of silicon, germanium, and SiOₓ (0<x<2).

It is desirable that the mixture be a mixture (hereinafter referred to as a “silicon based”) of graphite and silicon or SiOₓ (0<x<2). A formulation ratio of graphite and silicon or SiOₓ (0<x<2) is preferably 99:1 to 65:45 and more preferably 90:10 to 70:30.

A thickness of the negative electrode active material layer 2B is preferably 20 μm or more and 80 μm or less and more preferably 50 μm or more and 70 μm or less. Here, the thickness of the negative electrode active material layer 2B refers to a thickness of the negative electrode active material layer 2B disposed on one surface of the negative electrode current collector 2A.

An electrode density of the negative electrode active material layer 2B is preferably 1.4 g/cm³ or more and 1.7 g/cm³ or less and more preferably 1.5 g/cm³ or more and 1.6 g/cm³ or less. Here, the electrode density of the negative electrode active material layer 2B refers to an average density of the negative electrode active material layer 2B located on one surface of the negative electrode current collector 2A and including a negative electrode active material, a conductive material, and a binder.

The same negative electrode current collector 2A, conductive material, and binder as in the positive electrode 1 can be used as the negative electrode current collector 2A, the conductive material, and the binder. For example, cellulose, styrene/butadiene rubber, ethylene/propylene rubber, polyimide resins, polyamideimide resins, acrylic resins, and the like may be used as the binder used for the negative electrode in addition to the binders exemplified for the positive electrode.

A thickness of the negative electrode current collector 2A is preferably 6 μm or more and 15 μm or less, more preferably 8 μm or more and 12 μm or less, and even more preferably 10 μm.

The separator 3 may be formed of an electrically insulating porous structure. Examples of the separator 3 include a single layer of a film made of a polyolefin such as polyethylene or polypropylene, a laminated body, and a stretched film of a mixture made of the above resins, or a fiber nonwoven fabric including at least one constituent material selected from the group consisting of cellulose, polyester, polyacrylonitrile, polyamide, polyethylene, and polypropylene.

It is desirable that the wound body 10 in the secondary cell 100 with a nonaqueous electrolyte according to the embodiment include the positive electrode 1 using a composite metal oxide represented by the general expression: LiNiₓCo_{y}M_{z}O₂ (0.9≤x+y+z≤1.1, 0.6≤x<1, 0.2≤y≤0.4, 0.03≤z<0.2, and M indicates one or more elements selected from Al or Mn) as a positive electrode active material, the negative electrode 2 using a mixture (a mixed based) of graphite (natural graphite and artificial graphite) and any selected from the group consisting of silicon, germanium, and SiOₓ (0<x<2) as negative electrode active materials. By combining the positive electrode 1 and the negative electrode 2 of the wound body 10, it is possible to increase a charge/discharge capacity of the secondary cell with a nonaqueous electrolyte and improve the input characteristics of the secondary cell with a nonaqueous electrolyte.

A thickness of the separator 3 is preferably 6 μm or more and 20 μm or less, more preferably 9 μm or more and 15 μm or less, and even more preferably 10 μm.

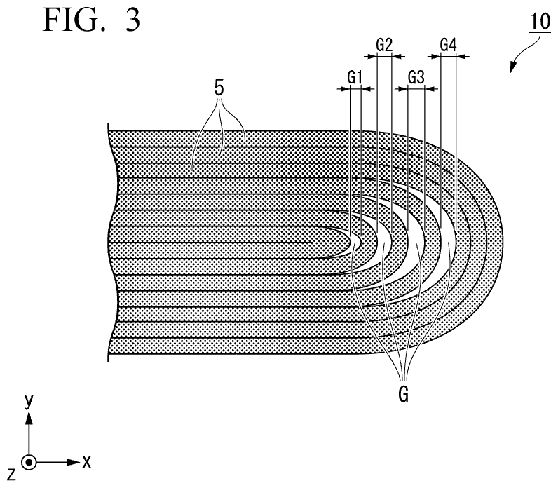

FIG. 3 is an enlarged cross-sectional schematic diagram of a characteristic part of the wound body in the secondary cell with a nonaqueous electrolyte according to the embodiment. FIG. 3 is a view of the wound body 10 when viewed in an axial direction of a winding axis thereof. Hereinafter, the axial direction is assumed to be a z direction, a major axis direction of the wound body 10 when the flat wound body 10 is viewed from the z direction is assumed to be an x direction, and a minor axis direction thereof is assumed to be a y direction.

The wound body 10 has gaps G in the x direction between adjacent electrode groups 5 in a central section in five layers from the inside of the wound body 10. If the gaps G are provided between the adjacent electrode groups 5 in the central section, it is possible to fully impregnate the wound body 10 with the electrolyte to a center thereof.

In an outer circumferential portion further outward in the wound body 10 from the central section thereof, the gaps G may or may not be present between adjacent electrode groups 5.

A length Gn (mm) in the x direction of the gap G fulfills a relationship of 0.09/n−0.003≤Gn≤0.98/n−0.093 (1≤n≤4). A length G1 in the x direction of a gap G between a first layered electrode group 5 and a second layered electrode group 5 fulfills 0.087 mm≤G1≤0.887 mm. A length G2 in the x direction of a gap G between the second layered electrode group 5 and a third layered electrode group 5 fulfills 0.042 mm≤G2≤0.397 mm. A length G3 in the x direction of a gap G between the third layered electrode group 5 and a fourth layered electrode group 5 fulfills 0.027 mm≤G3≤0.234 mm. A length G4 in the x direction of a gap G between the fourth layered electrode group 5 and a fifth layered electrode group 5 fulfills 0.0195 mm≤G4≤0.152 mm.

If the gaps G are arranged to have the above lengths, a density of the active material layers (the positive electrode active material layer 1B and the negative electrode active material layer 2B) in a curved section can be prevented from becoming excessively high compared to a density of the active material layers in the flat section. Furthermore, when the electrolyte fully enters the gaps G, a reaction can be efficiently performed also in the curved section and input characteristics of the secondary cell 100 with a nonaqueous electrolyte are improved. In addition, when the gaps G are not too wide, it is possible to prevent an unnecessarily long movement distance of ions responsible for conduction. If a movement distance of ions becomes longer, ions try to move only the shortest distance and local ion concentration easily occurs. This local ion concentration causes metal deposition and input characteristics of the secondary cell 100 with a nonaqueous electrolyte to deteriorate.

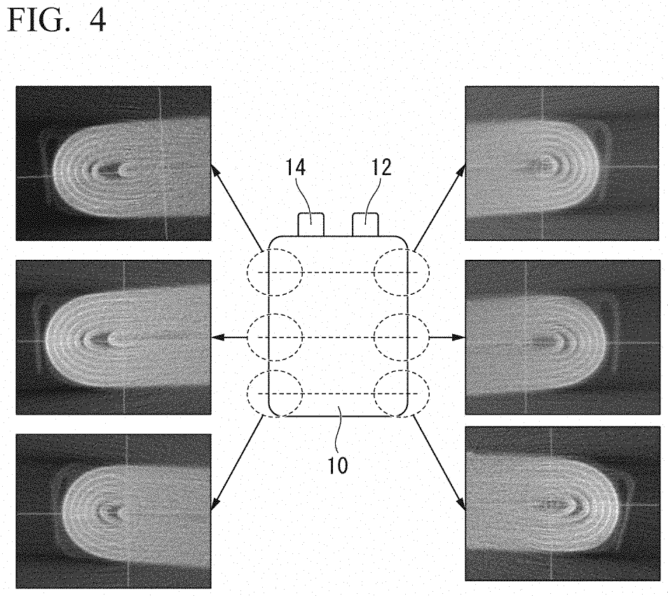

The lengths Gn (mm) in the x direction of the gaps G are each obtained from a transmission X-ray photograph using an X-ray CT (Computed Tomography) or an X-ray imaging device. FIG. 4 illustrates measurement results as a cross-sectional photograph of a characteristic part of a wound body using X-ray CT. As illustrated in FIG. 4, the gaps G are each observed when X-ray CT is used. When a width of the gap G is directly measured, it is possible to obtain the length Gn (mm) in the x direction of the gap G.

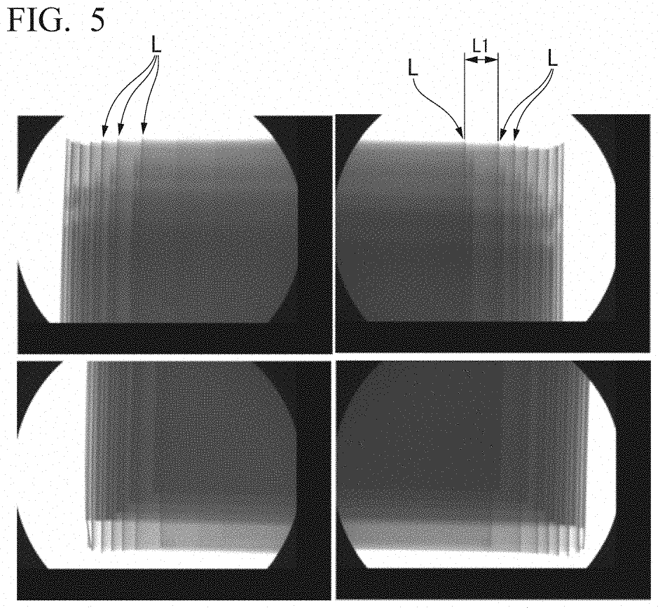

Also, FIG. 5 is a transmission X-ray photograph captured using an X-ray imaging device (manufactured by GUANGDONG ZHENGYE TECHNOLOGY Co., Ltd.; output 55 kW-45 μA). FIG. 5 is the photograph obtained by photographing four corners of the wound body 10 from the y direction. An upward/downward direction in FIG. 5 is the z direction and a leftward/rightward direction is the x direction. As illustrated in FIG. 5, in the transmission X-ray photograph, a plurality of lines L extending toward the z direction can be confirmed in the x direction. Each line L corresponds to an end portion of the negative electrode current collector 2A in the wound body 10. A plurality of lines L can be confirmed in accordance with the number of windings of the wound body 10. In FIG. 5, an outer side in a leftward/rightward direction is a winding outer side in the wound body 10.

By measuring a distance Ln in the x direction between adjacent negative electrode current collectors 2A and subtracting a length of constituent parts in the electrode group 5 from this distance, it is possible to calculate a length Gn in the x direction of the gap G. FIG. 5 illustrates a distance L1 in the x direction between the first layered negative electrode current collector 2A and the second layered negative electrode current collector 2B. The following relationship is achieved between the distance Ln between the negative electrode current collectors 2A and a length Gn of the gap G:

Length Gn=distance Ln−{“thickness of positive electrode current collector 1A”+(“thickness of positive electrode active material layer 1B”+“thickness of negative electrode active material layer 2B”+“thickness of separator 3”)×2}.

Here, the thickness of the positive electrode active material layer 1B and the thickness of the negative electrode active material layer 2B refer to a thickness of a layer laminated on one surface of the positive electrode current collector 1A or the negative electrode current collector 2A.

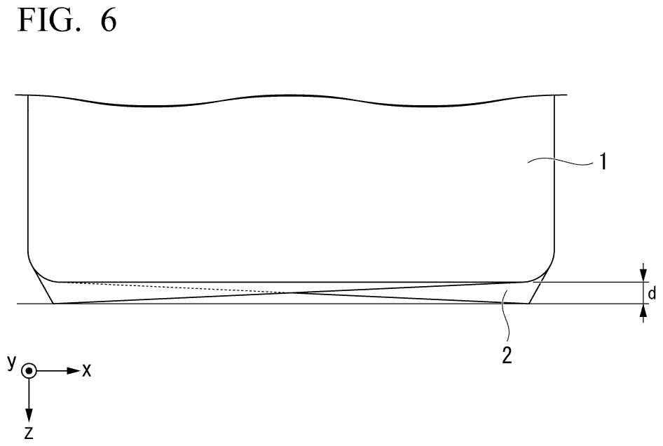

FIG. 6 is an enlarged schematic plan view of an end surface of the wound body 10 in the z direction. The wound body 10 is prepared by winding the positive electrode 1, the negative electrode 2, and the separator 3. It is desirable that the negative electrode 2 protrude outward from the adjacent positive electrodes 1. Here, in the case of the negative electrode 2 adjacent to the positive electrode 1, since the wound body 10 is obtained by winding the positive electrode 1 and the negative electrode 2, the negative electrode 2 is present on each of an inner surface and an outer surface of the positive electrode 1. It is desirable that the negative electrode 2 protrude outward from at least any one of the positive electrodes 1. An amount of protrusion d of the negative electrode protruding from the positive electrode 1 adjacent to the negative electrode 2 is preferably 0.5 mm or more and 2.5 mm or less and more preferably 1.0 mm or more and 1.6 mm or less.

If end portions of the positive electrode 1, the negative electrode 2, and the separator 3 are aligned and the wound body 10 is wound, an amount of protrusion is reduced. When the wound body 10 is wound, the more uniform the positive electrode 1, the negative electrode 2, and the separator 3, the more a uniform winding pressure applied to the wound body 10. That is to say, the winding of the wound body 10 becomes stronger and it is difficult for the electrolyte to enter the inside thereof. On the other hand, if the negative electrode 2 protrudes from the positive electrode 1 adjacent thereto, the winding pressure of the wound body 10 is reduced. Furthermore, the wound body 10 is loosened and the electrolyte easily enters the inside. In addition, the fact that an amount of protrusion of the negative electrode 2 with respect to the positive electrode 1 is within a predetermined range means that, even when a width of the unfolded negative electrode 2 in the y direction is wider than a width of the unfolded positive electrode 1 in the y direction, the negative electrode 2 does not meander significantly with respect to a central axis of the positive electrode 1 in the y direction at the time of winding. If the negative electrode 2 meanders significantly with respect to the positive electrode 1 at the time of winding, the wound body 10 is greatly loosened and a facing distance between the positive electrode 1 and the negative electrode 2 is increased.

(Nonaqueous Electrolyte)

As a nonaqueous electrolyte, an electrolyte solution containing a lithium salt or the like (an electrolyte solution using an aqueous electrolyte solution and an organic solvent) can be used. Here, since the aqueous electrolyte solution has an electrochemically low decomposition voltage, a withstand voltage during charging is limited to a low level. For this reason, it is desirable that the aqueous electrolyte solution be an electrolyte solution (a nonaqueous electrolyte solution) using an organic solvent.

A nonaqueous electrolyte is obtained by dissolving an electrolyte in a nonaqueous solvent and may contain a cyclic carbonate and a chain carbonate as a nonaqueous solvent.

As a cyclic carbonate, a cyclic carbonate in which an electrolyte can be used as a solvent can be used. For example, ethylene carbonate, propylene carbonate, butylene carbonate, and the like can be used as cyclic carbonate. It is desirable that the cyclic carbonates include at least propylene carbonate. Propylene carbonate has a low viscosity with respect to cyclic carbonates and immersion is easily impregnated into the gaps G provided in the central section of the wound body 10. When the electrolyte easily penetrates into the gap G, input characteristics of the secondary cell 100 with a nonaqueous electrolyte can be enhanced.

A chain carbonate can reduce the viscosity of a cyclic carbonate. Examples of chain carbonates include diethyl carbonate, dimethyl carbonate, and ethyl methyl carbonate. In addition, methyl acetate, ethyl acetate, methyl propionate, ethyl propionate, propyl propionate, γ-butyrolactone, 1,2-dimethoxyethane, 1,2-diethoxyethane, and the like may be used in combination.

A ratio between the cyclic carbonate and the chain carbonate in the nonaqueous solvent is preferably 1:1 or more and 1:9 or less by volume.

As an electrolyte, a metal salt can be used. For example, lithium salts such as LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF_{2 C}O)₂, and LiBOB can be used. One type of these lithium salts may be used individually and two or more types may be used together. Particularly, it is desirable that the electrolyte contain LiPF₆ in view of a degree of ionization.

When LiPF₆ is dissolved in a nonaqueous solvent, it is desirable to adjust a concentration of an electrolyte in a nonaqueous electrolyte to 0.5 mol/L or more and 2.0 mol/L or less. If a concentration of the electrolyte is 0.5 mol/L or more, it is possible to secure a sufficient concentration of lithium ions in the nonaqueous electrolyte and a sufficient capacity is then easily obtained during charging and discharging.

Furthermore, when a concentration of the electrolyte is minimized to within 2.0 mol/L, it is possible to minimize an increase in viscosity of the nonaqueous electrolyte and secure a sufficient mobility of lithium ions and sufficient capacity is then easily obtained during charging and discharging.

Also when LiPF₆ is mixed with other electrolytes, it is desirable to adjust a concentration of lithium ions in the nonaqueous electrolyte to 0.5 mol/L or more and 2.0 mol/L or less. It is more desirable that a concentration of lithium ions derived from LiPF₆ be 50 mol % or more with respect to the total amount of lithium ions in the nonaqueous electrolyte.

(Exterior Body)

The exterior body 20 has the wound body 10 and the electrolyte sealed therein. The exterior body 20 is not particularly limited as long as it can prevent leakage of the electrolyte outside, entry of moisture or the like from outside into the secondary cell 100 with a nonaqueous electrolyte, and the like.

For example, as the exterior body 20, a metal laminate film having a metal foil coated with a polymer film on both sides can be used. As a metal foil, for example, an aluminum foil can be used, and as a polymer film, a film made of polypropylene or the like can be used. For example, as a material for an outer polymer film, polymers having a high melting point, for example, polyethylene terephthalate (PET), polyamide, and the like are desirable, and as a material for an inner polymer film, polyethylene (PE), polypropylene (PP), and the like are desirable.

[Method for Producing Secondary Cell with Nonaqueous Electrolyte]

First, the positive electrode 1 and the negative electrode 2 are prepared. The positive electrode 1 and the negative electrode 2 differ only in the materials serving as active materials and can be prepared using the same production method.

First, a paint obtained by mixing a positive electrode active material, a binder, and a solvent is prepared. A conductive material may be further added as necessary. Examples of the solvent include water, N-methyl-2-pyrrolidone, N,N-dimethylformamide, and the like. A formulation ratio between the positive electrode active material, the conductive material, and the binder is preferably 80 wt % to 90 wt %:0.1 wt % to 10 wt %:0.1 wt % to 10 wt % as a mass ratio. This formulation is adjusted to 100 wt % as a whole.

A method of mixing these components constituting a paint is not particularly limited and a mixing order is not particularly limited. The positive electrode current collector 1A is coated with the paint. An application method is not particularly limited and a method which is usually employed at the time of preparing an electrode can be used. Examples of the application method include a slit die coating method and a doctor blade method. Similarly, also with regard to the negative electrode, the negative electrode current collector 2A is coated with the paint.

Subsequently, a solvent in the paint with which the positive electrode current collector 1A and the negative electrode current collector 2A are coated is removed. A removal method is not particularly limited. For example, the positive electrode current collector 1A and the negative electrode current collector 2A coated with the paint may be dried in an atmosphere of 80° C. to 150° C. Thus, the positive electrode 1 and the negative electrode 2 are completed.

Subsequently, the separator 3 is arranged between the positive electrode 1 and the negative electrode 2 which have been prepared and in a portion which is an outer side at the time of winding. Furthermore, these are wound using one end side (a left end in FIG. 2) of the positive electrode 1, the negative electrode 2, and the separator 3 as an axis. In the central section in five layers from the inside of the wound body 10, the wound body 10 is wound while a tensile strength is being adjusted so that a length between adjacent electrode groups is a predetermined length.

Finally, the wound body 10 is enclosed in the exterior body 20. The nonaqueous electrolyte is injected into the exterior body 20. The wound body 10 is immersed in the nonaqueous electrolyte by injecting the nonaqueous electrolyte and then decompressing, heating, or the like. The exterior body 20 is sealed by applying heat or the like.

As described above, in the secondary cell 100 with the nonaqueous electrolyte according to the embodiment, the gap G is formed to have a predetermined length in a central portion of the wound body 10. For this reason, the active material layer in the central section of the wound body 10 can also be immersed in sufficient electrolyte and input characteristics of the secondary cell 100 with the nonaqueous electrolyte are improved.

Although the embodiments of the present invention have been described in detail above with reference to the drawings, the constitutions of each embodiment, a combination thereof, and the like are examples and additions, omissions, substitutions, and other modifications can be performed without departing from the gist of the present invention.

### EXAMPLES

### Example 1

(Preparation of Evaluation Lithium-Ion Secondary Cell Full Cell)

Designing of a battery was performed by calculating a weight per unit area of a positive electrode such that a ratio between a product of a negative electrode active material capacity calculated in accordance with the measurement of a negative electrode active material capacity and a weight per unit area and a product of a positive electrode active material capacity and a weight per unit area fulfills the following relationship expression (1):

(negative electrode active material capacity×weight per unit area)/(positive electrode active material capacity×weight per unit area)=1.1 (1)

A negative electrode mixture was obtained by mixing natural graphite prepared as a negative electrode active material, acetylene black prepared as a conductive material, and polyvinylidene fluoride (PVDF) prepared as a binder. In the negative electrode mixture, a mass ratio of the negative electrode active material, the conductive material, and the binder was 94:2:4. A negative electrode mixture paint was prepared by dispersing this negative electrode mixture in N-methyl-2-pyrrolidone. Furthermore, one surface of copper foil with a thickness of 10 μm was coated with the paint so that an amount of coating was 6.1 mg/cm². After coating, the paint was dried at 100° C., a solvent was removed, and a negative electrode active material layer was formed. After that, the negative electrode active material layer was pressure-formed using a roll press to prepare a negative electrode. A thickness of the negative electrode active material layer formed on the one surface in the negative electrode current collector was 62 μm and the total thickness of the negative electrode was 134 μm. An average electrode density of the prepared negative electrode active material layer was (1.50 g/cm³).

A positive electrode mixture was obtained by mixing LiCoO₂ prepared as a positive electrode active material, acetylene black prepared as a conductive material, and polyvinylidene fluoride (PVDF) prepared as a binder. In the positive electrode mixture, a mass ratio of the positive electrode active material, the conductive material, and the binder was 90:5:5. A positive electrode mixture paint was prepared by dispersing this positive electrode mixture in N-methyl-2-pyrrolidone. Furthermore, one surface of aluminum foil with the thickness of 15 μm was coated with the paint so that an amount of coating was a calculated weight per unit area of the positive electrode. After coating, the paint was dried at 100° C., a solvent was removed, and a positive electrode active material layer was formed. After that, the positive electrode active material layer was pressure-formed using a roll press to prepare a positive electrode. A thickness of the positive electrode active material layer formed on the one surface of the positive electrode current collector was 42 μm and the total thickness of the positive electrode was 99 μm.

In order to calculate an average electrode density of the prepared positive electrode, a weight per unit area of the positive electrode active material layer at five places on the positive electrode was calculated and this average value was divided by 42 μm which is the thickness of the positive electrode active material layer formed on the one surface. The calculated average electrode density of the positive electrode active material layer was 3.4 g/cm³.

Also, polyethylene was prepared as a separator. A thickness of the separator was 10 μm. The positive electrode and the negative electrode were laminated with the separator therebetween to prepare an electrode group. The electrode group was wound to prepare a wound body. The number of windings in the wound body was seven. The negative electrode protruded 0.2 mm in the axial direction (the z direction) of the wound body.

Furthermore, the wound body was accommodated in the exterior body and immersed in a nonaqueous electrolyte. An aluminum laminate film was used for the exterior body. A nonaqueous electrolyte obtained by adding 1.0 M (mol/L) of LiPF₆ as a lithium salt to a solvent obtained using ethylene carbonate (EC) and diethyl carbonate (DEC) with a volume ratio of 3:7 was used for the nonaqueous electrolyte. A secondary cell with a nonaqueous electrolyte (a full cell) was prepared by sealing an outer circumference of the exterior body while a pressure in the exterior body was reduced.

(Measurement of Input Characteristics)

The input characteristics of a secondary cell with a nonaqueous electrolyte were measured using a secondary cell charge/discharge test device. The input characteristics were evaluated with a voltage range of 4.2 V to 3.0 V, 1 C=3500 mAh per full cell design capacity, and a 2 C capacity retention rate (%). The 2 C capacity retention rate is a ratio of a charging capacity at the time of 2 C constant current charging with respect to an amount of 0.2 C charging using a constant current-constant voltage charging capacity at the time of 0.2 C charging as a reference and is represented by the following expression (1):

(2 C capacity retention rate (%))=(charging capacity at the time of 2 C constant current)/(constant current-constant voltage charging capacity at the time of 0.2 C charging)×100 (1).

This means that, when this 2 C capacity retention rate is higher, excellent quick charge characteristics are provided, and excellent input characteristics of the secondary cell with the nonaqueous electrolyte are provided. The measurement results are illustrated in Table 1.

### Examples 2 to 21 and Comparative Examples 1 to 30

Examples 2 to 21 and Comparative Examples 1 to 30 are different from Example 1 in that, in Examples 2 to 21 and Comparative Examples 1 to 30, the conditions for the winding of the wound body were changed and a width of a gap between adjacent electrode groups was changed. Other conditions were the same as in Example 1. Table 1 shows the measurement results for the examples and Table 2 shows the measurement results for the comparative examples.

TABLE 1

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 1 | 0.091 | 0.045 | 0.031 | 0.0250 | 3.4 | EC/DMC = 30/70 | 0.2 | 81 |
| Example 2 | 0.110 | 0.072 | 0.035 | 0.0550 | 3.4 | EC/DMC = 30/70 | 0.2 | 80 |
| Example 3 | 0.140 | 0.120 | 0.082 | 0.0750 | 3.4 | EC/DMC = 30/70 | 0.2 | 82 |
| Example 4 | 0.550 | 0.210 | 0.095 | 0.0800 | 3.4 | EC/DMC = 30/70 | 0.2 | 81 |
| Example 5 | 0.720 | 0.290 | 0.150 | 0.0900 | 3.4 | EC/DMC = 30/70 | 0.2 | 83 |
| Example 6 | 0.820 | 0.310 | 0.190 | 0.1100 | 3.4 | EC/DMC = 30/70 | 0.2 | 79 |
| Example 7 | 0.850 | 0.380 | 0.220 | 0.1400 | 3.4 | EC/DMC = 30/70 | 0.2 | 80 |
| Example 8 | 0.092 | 0.397 | 0.027 | 0.0200 | 3.4 | EC/DMC = 30/70 | 0.2 | 80 |
| Example 9 | 0.090 | 0.042 | 0.234 | 0.0210 | 3.4 | EC/DMC = 30/70 | 0.2 | 82 |
| Example 10 | 0.089 | 0.046 | 0.030 | 0.1520 | 3.4 | EC/DMC = 30/70 | 0.2 | 79 |
| Example 11 | 0.088 | 0.397 | 0.234 | 0.0220 | 3.4 | EC/DMC = 30/70 | 0.2 | 80 |
| Example 12 | 0.091 | 0.395 | 0.029 | 0.1500 | 3.4 | EC/DMC = 30/70 | 0.2 | 82 |
| Example 13 | 0.087 | 0.044 | 0.230 | 0.1520 | 3.4 | EC/DMC = 30/70 | 0.2 | 79 |
| Example 14 | 0.089 | 0.395 | 0.230 | 0.1500 | 3.4 | EC/DMC = 30/70 | 0.2 | 81 |
| Example 15 | 0.886 | 0.043 | 0.027 | 0.0210 | 3.4 | EC/DMC = 30/70 | 0.2 | 82 |
| Example 16 | 0.887 | 0.045 | 0.233 | 0.0220 | 3.4 | EC/DMC = 30/70 | 0.2 | 80 |
| Example 17 | 0.885 | 0.042 | 0.031 | 0.1500 | 3.4 | EC/DMC = 30/70 | 0.2 | 78 |
| Example 18 | 0.884 | 0.044 | 0.232 | 0.1510 | 3.4 | EC/DMC = 30/70 | 0.2 | 83 |
| Example 19 | 0.887 | 0.395 | 0.030 | 0.0250 | 3.4 | EC/DMC = 30/70 | 0.2 | 82 |
| Example 20 | 0.083 | 0.394 | 0.032 | 0.1490 | 3.4 | EC/DMC = 30/70 | 0.2 | 80 |
| Example 21 | 0.886 | 0.396 | 0.231 | 0.0195 | 3.4 | EC/DMC = 30/70 | 0.2 | 81 |

TABLE 2

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Comparative | 0.085 | 0.039 | 0.025 | 0.0150 | 3.4 | EC/DMC = 30/70 | 0.2 | 70 |
| Example 1 | | | | | | | | |
| Comparative | 0.088 | 0.040 | 0.026 | 0.0160 | 3.4 | EC/DMC = 30/70 | 0.2 | 71 |
| Example 2 | | | | | | | | |
| Comparative | 0.090 | 0.045 | 0.025 | 0.0150 | 3.4 | EC/DMC = 30/70 | 0.2 | 71 |
| Example 3 | | | | | | | | |
| Comparative | 0.091 | 0.044 | 0.029 | 0.0160 | 3.4 | EC/DMC = 30/70 | 0.2 | 72 |
| Example 4 | | | | | | | | |
| Comparative | 0.910 | 0.390 | 0.240 | 0.1500 | 3.4 | EC/DMC = 30/70 | 0.2 | 70 |
| Example 5 | | | | | | | | |
| Comparative | 0.900 | 0.420 | 0.220 | 0.1400 | 3.4 | EC/DMC = 30/70 | 0.2 | 70 |
| Example 6 | | | | | | | | |
| Comparative | 0.910 | 0.430 | 0.250 | 0.1500 | 3.4 | EC/DMC = 30/70 | 0.2 | 69 |
| Example 7 | | | | | | | | |
| Comparative | 0.900 | 0.410 | 0.240 | 0.1600 | 3.4 | EC/DMC = 30/70 | 0.2 | 68 |
| Example 8 | | | | | | | | |
| Comparative | 0.910 | 0.210 | 0.095 | 0.1900 | 3.4 | EC/DMC = 30/70 | 0.2 | 70 |
| Example 9 | | | | | | | | |
| Comparative | 0.850 | 0.290 | 0.150 | 0.1600 | 3.4 | EC/DMC = 30/70 | 0.2 | 69 |
| Example 10 | | | | | | | | |
| Comparative | 0.086 | 0.043 | 0.029 | 0.0182 | 3.4 | EC/DMC = 30/70 | 0.2 | 70 |
| Example 11 | | | | | | | | |
| Comparative | 0.088 | 0.040 | 0.028 | 0.0194 | 3.4 | EC/DMC = 30/70 | 0.2 | 70 |
| Example 12 | | | | | | | | |
| Comparative | 0.085 | 0.045 | 0.026 | 0.0187 | 3.4 | EC/DMC = 30/70 | 0.2 | 68 |
| Example 13 | | | | | | | | |
| Comparative | 0.084 | 0.041 | 0.030 | 0.0170 | 3.4 | EC/DMC = 30/70 | 0.2 | 70 |
| Example 14 | | | | | | | | |
| Comparative | 0.088 | 0.044 | 0.026 | 0.0200 | 3.4 | EC/DMC = 30/70 | 0.2 | 69 |
| Example 15 | | | | | | | | |
| Comparative | 0.090 | 0.040 | 0.025 | 0.0210 | 3.4 | EC/DMC = 30/70 | 0.2 | 70 |
| Example 16 | | | | | | | | |
| Comparative | 0.085 | 0.045 | 0.024 | 0.0230 | 3.4 | EC/DMC = 30/70 | 0.2 | 70 |
| Example 17 | | | | | | | | |
| Comparative | 0.088 | 0.045 | 0.023 | 0.0220 | 3.4 | EC/DMC = 30/70 | 0.2 | 70 |
| Example 18 | | | | | | | | |
| Comparative | 0.089 | 0.040 | 0.029 | 0.0300 | 3.4 | EC/DMC = 30/70 | 0.2 | 70 |
| Example 19 | | | | | | | | |
| Comparative | 0.085 | 0.041 | 0.028 | 0.0200 | 3.4 | EC/DMC = 30/70 | 0.2 | 70 |
| Example 20 | | | | | | | | |
| Comparative | 0.086 | 0.039 | 0.025 | 0.0220 | 3.4 | EC/DMC = 30/70 | 0.2 | 70 |
| Example 21 | | | | | | | | |
| Comparative | 0.860 | 0.410 | 0.240 | 0.1580 | 3.4 | EC/DMC = 30/70 | 0.2 | 68 |
| Example 22 | | | | | | | | |
| Comparative | 0.850 | 0.400 | 0.150 | 0.1510 | 3.4 | EC/DMC = 30/70 | 0.2 | 70 |
| Example 23 | | | | | | | | |
| Comparative | 0.870 | 0.398 | 0.244 | 0.1500 | 3.4 | EC/DMC = 30/70 | 0.2 | 69 |
| Example 24 | | | | | | | | |
| Comparative | 0.850 | 0.420 | 0.150 | 0.1630 | 3.4 | EC/DMC = 30/70 | 0.2 | 70 |
| Example 25 | | | | | | | | |
| Comparative | 0.880 | 0.410 | 0.256 | 0.1590 | 3.4 | EC/DMC = 30/70 | 0.2 | 70 |
| Example 26 | | | | | | | | |
| Comparative | 0.900 | 0.405 | 0.150 | 0.1600 | 3.4 | EC/DMC = 30/70 | 0.2 | 70 |
| Example 27 | | | | | | | | |
| Comparative | 0.860 | 0.300 | 0.255 | 0.1500 | 3.4 | EC/DMC = 30/70 | 0.2 | 68 |
| Example 28 | | | | | | | | |
| Comparative | 0.850 | 0.290 | 0.236 | 0.1610 | 3.4 | EC/DMC = 30/70 | 0.2 | 70 |
| Example 29 | | | | | | | | |
| Comparative | 0.900 | 0.330 | 0.250 | 0.1670 | 3.4 | EC/DMC = 30/70 | 0.2 | 69 |
| Example 30 | | | | | | | | |

In all of Examples 1 to 21 in which gaps were formed with predetermined lengths, the secondary cell with the nonaqueous electrolyte had a high 2 C capacity retention rate and excellent input rate characteristics. On the other hand, in Comparative Examples 1 to 30 in which a length of a gap was wide or narrow, adequate input rate characteristics were exhibited. It is thought that, when the gap was narrow, the central section could not be sufficiently immersed in the electrolyte. It is thought that, when the gap was too wide, the movement distance of Li ions increased and input rate characteristics deteriorated.

### Examples 22 to 32

Examples 22 to 32 and Example 1 differ in that, in Examples 22 to 32, the conditions of the winding of a wound body were changed and an amount of protrusion of a negative electrode in the axial direction of the wound body was changed. In Example 22 to 29, the other conditions were the same as in Example 1. In Examples 30 to 32, a composition of the electrolyte was changed at the same time. In Example 16, a solvent obtained using propylene carbonate (PC), ethylene carbonate (EC), and diethyl carbonate (DEC) at a volume ratio of 5:25:70 was used as an electrolyte. In Example 17, a solvent obtained using PC, EC, and DEC at a volume ratio of 10:20:70 was used as an electrolyte. In Example 18, a solvent obtained using PC, EC, and DEC at a volume ratio of 15:15:70 was used as an electrolyte. Table 3 shows the measurement results.

TABLE 3

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 22 | 0.150 | 0.130 | 0.080 | 0.0700 | 3.4 | EC/DMC = 30/70 | 0.5 | 84 |
| Example 23 | 0.550 | 0.160 | 0.170 | 0.0900 | 3.4 | EC/DMC = 30/70 | 0.9 | 85 |
| Example 24 | 0.790 | 0.190 | 0.150 | 0.0800 | 3.4 | EC/DMC = 30/70 | 1.0 | 88 |
| Example 25 | 0.340 | 0.140 | 0.090 | 0.0900 | 3.4 | EC/DMC = 30/70 | 1.5 | 87 |
| Example 26 | 0.320 | 0.170 | 0.160 | 0.0700 | 3.4 | EC/DMC = 30/70 | 1.6 | 88 |
| Example 27 | 0.260 | 0.190 | 0.130 | 0.0800 | 3.4 | EC/DMC = 30/70 | 2.5 | 86 |
| Example 28 | 0.160 | 0.200 | 0.090 | 0.0700 | 3.4 | EC/DMC = 30/70 | 2.6 | 79 |
| Example 29 | 0.620 | 0.180 | 0.140 | 0.0900 | 3.4 | EC/DMC = 30/70 | 2.8 | 80 |
| Example 30 | 0.800 | 0.180 | 0.160 | 0.0900 | 3.4 | PC/EC/DMC = 5/25/70 | 1.3 | 90 |
| Example 31 | 0.780 | 0.190 | 0.170 | 0.0700 | 3.4 | PC/EC/DMC = 10/20/70 | 1.4 | 91 |
| Example 32 | 0.790 | 0.180 | 0.150 | 0.0900 | 3.4 | PC/EC/DMC = 15/15/70 | 1.3 | 90 |

If an amount of protrusion of the negative electrode with respect to the positive electrode was within a predetermined range, a 2 C capacity retention rate of the secondary cell with the nonaqueous electrolyte was improved. Furthermore, the same effects were obtained even when the electrolyte composition was changed.

### Examples 33 to 39 and Comparative Examples 31 to 34

Examples 33 to 39 and Comparative Examples 31 to 34 are different from Example 1 in that, in Examples 33 to 39 and Comparative Examples 31 to 34, a positive electrode active material was changed from LiCoO₂ to LiNi_{0.85}Co_{0.1}Al_{0.05}O₂. The other conditions were the same as in Example 1. Electrode densities in these examples and comparative examples were calculated in the same manner as in Example 1. Table 4 shows the measurement results.

TABLE 4

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 33 | 0.093 | 0.046 | 0.032 | 0.0250 | 3.4 | EC/DMC = 30/70 | 0.2 | 81 |
| Example 34 | 0.210 | 0.063 | 0.045 | 0.0540 | 3.4 | EC/DMC = 30/70 | 0.2 | 81 |
| Example 35 | 0.310 | 0.130 | 0.092 | 0.0770 | 3.4 | EC/DMC = 30/70 | 0.2 | 82 |
| Example 36 | 0.560 | 0.210 | 0.096 | 0.0940 | 3.4 | EC/DMC = 30/70 | 0.2 | 83 |
| Example 37 | 0.720 | 0.280 | 0.160 | 0.0970 | 3.4 | EC/DMC = 30/70 | 0.2 | 83 |
| Example 38 | 0.830 | 0.330 | 0.210 | 0.1200 | 3.4 | EC/DMC = 30/70 | 0.2 | 79 |
| Example 39 | 0.860 | 0.380 | 0.230 | 0.1450 | 3.4 | EC/DMC = 30/70 | 0.2 | 80 |
| Comparative | 0.085 | 0.039 | 0.025 | 0.0150 | 3.4 | EC/DMC = 30/70 | 0.2 | 69 |
| Example 31 | | | | | | | | |
| Comparative | 0.088 | 0.040 | 0.026 | 0.0160 | 3.4 | EC/DMC = 30/70 | 0.2 | 70 |
| Example 32 | | | | | | | | |
| Comparative | 0.090 | 0.045 | 0.025 | 0.0150 | 3.4 | EC/DMC = 30/70 | 0.2 | 71 |
| Example 33 | | | | | | | | |
| Comparative | 0.091 | 0.044 | 0.029 | 0.0160 | 3.4 | EC/DMC = 30/70 | 0.2 | 71 |
| Example 34 | | | | | | | | |

### Examples 40 to 46 and Comparative Examples 35 to 38

Examples 40 to 46 and Comparative Examples 35 to 38 are different from Example 1 in that, in Examples 40 to 46 and Comparative Examples 35 to 38, a positive electrode active material was changed from LiCoO₂ to LiNi_{0.8}Co_{0.1}Mn_{0.1}O₂. The other conditions were the same as in Example 1. Electrode densities in these examples and comparative examples were calculated in the same manner as in Example 1. Table 5 shows the measurement results.

TABLE 5

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 40 | 0.089 | 0.044 | 0.029 | 0.0200 | 3.4 | EC/DMC = 30/70 | 0.2 | 81 |
| Example 41 | 0.150 | 0.071 | 0.039 | 0.0620 | 3.4 | EC/DMC = 30/70 | 0.2 | 80 |
| Example 42 | 0.330 | 0.140 | 0.091 | 0.0790 | 3.4 | EC/DMC = 30/70 | 0.2 | 82 |
| Example 43 | 0.540 | 0.240 | 0.097 | 0.0920 | 3.4 | EC/DMC = 30/70 | 0.2 | 82 |
| Example 44 | 0.710 | 0.260 | 0.180 | 0.0960 | 3.4 | EC/DMC = 30/70 | 0.2 | 83 |
| Example 45 | 0.840 | 0.320 | 0.200 | 0.1300 | 3.4 | EC/DMC = 30/70 | 0.2 | 80 |
| Example 46 | 0.870 | 0.390 | 0.220 | 0.1500 | 3.4 | EC/DMC = 30/70 | 0.2 | 79 |
| Comparative | 0.086 | 0.037 | 0.023 | 0.0140 | 3.4 | EC/DMC = 30/70 | 0.2 | 70 |
| Example 35 | | | | | | | | |
| Comparative | 0.091 | 0.041 | 0.024 | 0.0160 | 3.4 | EC/DMC = 30/70 | 0.2 | 71 |
| Example 36 | | | | | | | | |
| Comparative | 0.094 | 0.047 | 0.026 | 0.0180 | 3.4 | EC/DMC = 30/70 | 0.2 | 71 |
| Example 37 | | | | | | | | |
| Comparative | 0.120 | 0.051 | 0.029 | 0.0170 | 3.4 | EC/DMC = 30/70 | 0.2 | 72 |
| Example 38 | | | | | | | | |

As shown in Tables 4 and 5, it was confirmed that, even if a positive electrode active material was changed, when a gap fulfills having a predetermined range, input rate characteristics of the secondary cell with the nonaqueous electrolyte were improved.

### Examples 47 to 53 and Comparative Examples 39 to 42

Examples 47 to 53 and Comparative Examples 39 to 42 are different from Example 1 in that, in Examples 47 to 53 and Comparative Examples 39 to 42, a negative electrode active material was changed from graphite to a mixture (a silicon based) of graphite and Si. A weight ratio between graphite and Si in the negative electrode active material was 80:20. A thickness of a negative electrode active material layer formed on one surface of a negative electrode current collector was 52 μm and the total thickness of a negative electrode was 115 μm. The other conditions were the same as in Example 1. Electrode densities in these examples and comparative examples were calculated in the same manner as in Example 1. Table 6 shows the measurement results.

TABLE 6

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 47 | 0.091 | 0.046 | 0.028 | 0.0210 | 3.4 | EC/DMC = 30/70 | 0.2 | 80 |
| Example 48 | 0.120 | 0.082 | 0.041 | 0.0650 | 3.4 | EC/DMC = 30/70 | 0.2 | 80 |
| Example 49 | 0.340 | 0.110 | 0.089 | 0.0760 | 3.4 | EC/DMC = 30/70 | 0.2 | 81 |
| Example 50 | 0.530 | 0.270 | 0.095 | 0.0890 | 3.4 | EC/DMC = 30/70 | 0.2 | 82 |
| Example 51 | 0.740 | 0.290 | 0.140 | 0.0990 | 3.4 | EC/DMC = 30/70 | 0.2 | 83 |
| Example 52 | 0.830 | 0.330 | 0.220 | 0.1200 | 3.4 | EC/DMC = 30/70 | 0.2 | 81 |
| Example 53 | 0.880 | 0.370 | 0.230 | 0.1400 | 3.4 | EC/DMC = 30/70 | 0.2 | 79 |
| Comparative | 0.083 | 0.035 | 0.022 | 0.0120 | 3.4 | EC/DMC = 30/70 | 0.2 | 70 |
| Example 39 | | | | | | | | |
| Comparative | 0.093 | 0.039 | 0.023 | 0.0180 | 3.4 | EC/DMC = 30/70 | 0.2 | 70 |
| Example 40 | | | | | | | | |
| Comparative | 0.095 | 0.044 | 0.024 | 0.0190 | 3.4 | EC/DMC = 30/70 | 0.2 | 69 |
| Example 41 | | | | | | | | |
| Comparative | 0.150 | 0.050 | 0.029 | 0.0160 | 3.4 | EC/DMC = 30/70 | 0.2 | 71 |
| Example 42 | | | | | | | | |

As shown in Table 6, it was confirmed that, even when a negative electrode active material was changed, when a gap fulfills having a predetermined range, input rate characteristics of the secondary cell with the nonaqueous electrolyte were improved.

### Example 54 to 60

Examples 54 to 60 and Example 40 differ in that, in Examples 54 to 60, an electrode density of a positive electrode active material layer was changed. The positive electrode active material was LiNi_{0.8}Co_{0.1}Mn_{0.1}O₂ as in Example 40. The electrode density of the positive electrode active material layer was changed by adjusting a pressing pressure or the like when the positive electrode active material layer was prepared. The other conditions were the same as in Example 1. Electrode densities in these examples were calculated in the same manner as in Example 1. Table 7 shows the measurement results.

TABLE 7

| | | | | | | | Amount of | Input Rate |
|---|---|---|---|---|---|---|---|---|
| | | | | | | | Protrusion of | Characteristics |
| | G1 [nm] | G2 [nm] | G3 [nm] | G4 [nm] | Electrode | | Negative | 2 C Capacity |
| | 0.087 ≤ | 0.042 ≤ | 0.027 ≤ | 0.0195 ≤ | Density | Electrolyte | Electrode | Retention Rate |
| | G1 ≤ 0.887 | G2 ≤ 0.397 | G3 ≤ 0.234 | G4 ≤ 0.152 | [g/cm³] | Composition | [mm] | [%] |
| Example 54 | 0.095 | 0.043 | 0.032 | 0.0220 | 2.9 | EC/DMC = 30/70 | 0.2 | 76 |
| Example 55 | 0.091 | 0.045 | 0.031 | 0.0260 | 3.0 | EC/DMC = 30/70 | 0.2 | 81 |
| Example 56 | 0.096 | 0.044 | 0.030 | 0.0250 | 3.3 | EC/DMC = 30/70 | 0.2 | 86 |
| Example 57 | 0.092 | 0.046 | 0.034 | 0.0240 | 3.5 | EC/DMC = 30/70 | 0.2 | 86 |
| Example 58 | 0.094 | 0.045 | 0.033 | 0.0210 | 3.8 | EC/DMC = 30/70 | 0.2 | 85 |
| Example 59 | 0.960 | 0.043 | 0.031 | 0.0230 | 3.9 | EC/DMC = 30/70 | 0.2 | 80 |
| Example 60 | 0.090 | 0.044 | 0.032 | 0.0250 | 4.0 | EC/DMC = 30/70 | 0.2 | 75 |

Even when the electrode density of the positive electrode active material layer was high, excellent input rate characteristics of the secondary cell with the nonaqueous electrolyte could be maintained.

### REFERENCE SIGNS LIST

1 Positive electrode
1A Positive electrode current collector
1B Positive electrode active material layer
2 Negative electrode
2A Negative electrode current collector
2B Negative electrode active material layer
3 Separator
4 Insulating tape
5 Electrode group
10 Wound body
12 Positive electrode terminal
14 Negative electrode terminal
20 Exterior body
100 Secondary cell with nonaqueous electrolyte
K Accommodation space
G Gap

1. A secondary cell with a nonaqueous electrolyte, comprising:
a wound body in which an electrode group including a positive electrode, a negative electrode, and a separator sandwiched therebetween is wound in a flat shape; and
a nonaqueous electrolyte having the wound body immersed therein,
wherein the wound body, in a central section within at least five layers from the inside of the wound body, includes a gap between adjacent layers of the electrode group and
a length Gn of the gap in a major axis direction of the wound body when viewed from an axial direction of the wound body fulfills a relationship of 0.09/n−0.003≤Gn≤0.98/n−0.093 (1≤n≤4).

2. The secondary cell with a nonaqueous electrolyte according to claim 1, wherein, at any end surface of the wound body in the axial direction, the negative electrode protrudes further outward in the axial direction from the adjacent positive electrode, and
an amount of protrusion is 0.5 mm or more and 2.5 mm or less.

3. The secondary cell with a nonaqueous electrolyte according to claim 1, wherein the nonaqueous electrolyte includes a cyclic carbonate and a chain carbonate, and
the cyclic carbonate includes at least propylene carbonate.

4. The secondary cell with a nonaqueous electrolyte according to claim 1, wherein an electrode density of the positive electrode is 3.0 g/cm³ or more and 3.9 g/cm³ or less.
